(19) United States
(12) Patent Application Publication
(10) Pub. No.: US 2021/0372483 A1
(43) Pub. Date: Dec. 2, 2021

(54) FREE-RUNNING ABSORBER ARRANGEMENT FOR A MOTOR VEHICLE

(71) Applicant: BorgWarner Inc., Auburn Hills, MI (US)

(72) Inventors: Tobias Kaufhold, Sandhausen (DE); Jochen Bölling, Baden-Baden (DE); Friedrich Philipp Brezger, Karlsruhe (DE); Oliver Groneberg, St. Leon-Rot (DE); Yun Kai LIM, Mannheim (DE); Alexander Moser, Ketsch (DE); Florian Schneider, Hockenheim (DE)

(21) Appl. No.: 17/303,428

(22) Filed: May 28, 2021

(30) Foreign Application Priority Data
May 29, 2020 (DE) 102020003257.5
Jun. 3, 2020 (DE) 102020003347.4
Mar. 25, 2021 (DE) 102021001566.5

(51) Int. Cl. F16D 3/12; F16D 41/064; F16F 15/123; F02N 11/00

(52) U.S. Cl. CPC F16D 3/12; F16D 41/064; F16F 2236/08; F02N 11/003; F16F 2232/02; F16F 15/123

(57) ABSTRACT

The present invention relates to a freewheel damper arrangement (2) for a motor vehicle having a torsional vibration damper (18) having a damper shell (22), spring elements (30) arranged in the damper shell (22) and a damper flange (34) coupled torsionally elastically to the damper shell (22) via the spring elements (30), and a starter freewheel (20) having a first race (58) which can be driven by a starter motor (70) and a second race (60) which is assigned to the damper shell (22), between which clamping elements (62) are arranged. The second race (60) is non-rotatably fastened to the damper shell (22).

### CROSS-REFERENCE TO RELATED APPLICATIONS

This application claims priority pursuant to 35 U.S.C. 119(a) of German Patent Application No. 102020003257.5 filed May 29, 2020, German Patent Application No. 102020003347.4 filed Jun. 3, 2020, and German Patent Application No. 102021001566.5 filed Mar. 25, 2021, which applications are herein incorporated by reference in the entirety.

### SUMMARY

The present invention relates to a freewheel damper arrangement for a motor vehicle, having a torsional vibration damper with a damper shell, spring elements arranged in the damper shell and a damper flange coupled torsionally elastically to the damper shell via the spring elements, and a starter freewheel with a first race which can be driven by a starter motor and a second race which is assigned to the damper shell and between which clamping elements are arranged.

Drive trains within a motor vehicle in which a freewheel damper arrangement is provided are known in the field. Such a freewheel damper arrangement firstly comprises a torsional vibration damper. The torsional vibration damper has a damper shell, spring elements arranged in the damper shell and a damper flange coupled torsionally elastically to the damper shell via the spring elements. The torsional vibration damper serves to damp torsional vibrations caused by torsional shocks of the internal combustion engine. In order to start the internal combustion engine, a starter motor is also provided, which interacts directly or indirectly with the crankshaft of the internal combustion engine via a starter freewheel. The starter freewheel has a first race which can be driven by the starter motor and a second race associated with the crankshaft of the internal combustion engine, between which clamping elements are arranged. In freewheel damper arrangements known in the field, the starter freewheel is arranged in the axial direction between the internal combustion engine and the torsional vibration damper, wherein the second race is in rotary driving connection with the end of the crankshaft or an input hub of the torsional vibration damper. For this purpose, the second race of the starter freewheel is connected to the input hub of the torsional vibration damper or the end of the crankshaft via a torque transmission element in the form of an annular disc.

The known freewheel damper arrangements have proved to be expedient, but are disadvantageous in that they have a relatively space-intensive structure both in the axial direction and in the radial direction.

It is therefore an object of the present invention to design a freewheel damper arrangement of the generic type in such a way that it has a particularly compact structure and is easy to assemble.

This object is solved by the features specified in claim 1. Advantageous embodiments of the invention are the subject matter of the sub-claims.

The freewheel damper arrangement according to the invention is designed for the drive train of a motor vehicle, wherein the freewheel damper arrangement is preferably used between an internal combustion engine on the one hand and a transmission on the other within the drive train. The freewheel damper arrangement has a torsional vibration damper. The torsional vibration damper has a damper shell which is preferably composed of two damper half-shells. The damper shell also preferably forms the primary element of the torsional vibration damper or its input side within the drive train of the motor vehicle, into which input side the torque of the drive unit of the motor vehicle, preferably of the internal combustion engine, is introduced. Spring elements are arranged in the damper shell, which can be coil springs, for example, preferably in the form of straight or curved coil springs. In addition, the torsional vibration damper has a damper flange which is torsionally coupled to the damper shell via the spring elements and is preferably the secondary element of the torsional vibration damper or its output side. In addition, the freewheel damper arrangement has a starter freewheel via which the associated drive unit of the drive train, preferably the internal combustion engine, can be started by a starter motor. The starter motor is preferably an electric drive or an electric machine. Thus, the starter freewheel has a first race that can be driven by the starter motor and a second race assigned to the damper shell, such that—in relation to the starter motor—one can also speak of a first race on the input side and a second race on the output side. Clamping elements are arranged between the first race and the second race, which are preferably clamping rollers that are particularly preferably coin-shaped. Also, the clamping rollers preferably have a circular periphery in order to be able to roll on the first and/or second race. The starter freewheel is preferably designed in such a way that it transmits a rotation of the first race in a first direction of rotation relative to the second race to the second race by the clamping elements assuming a clamping position between the first and second race, while a rotation of the first race in a second direction of rotation relative to the second race cannot be transmitted to the second race. Thanks to this design, the starter freewheel can be a permanently engaged starter motor or starter freewheel, as is preferred in the present invention, in order to avoid a time-consuming separation of starter motor and start freewheel. In order to achieve a particularly compact design of the freewheel damper arrangement both in the axial direction and in the radial direction, and also to reduce the number of parts and the weight, the second race of the starter freewheel is non-rotatably fixed on the damper shell. Consequently, an additional torque transmission element between the second race of the starter freewheel and the crankshaft of the internal combustion engine or the input hub of the torsional vibration damper can be dispensed with in an advantageous manner in order to non-rotatably fasten the second race of the starter freewheel directly or indirectly to the damper shell of the torsional vibration damper of the freewheel damper arrangement.

To ensure simple assembly of the freewheel damper arrangement, in a preferred embodiment of the freewheel damper arrangement according to the invention, the second race is non-rotatably fixed to the damper shell by means of an axial plug-in connection. For this purpose, it is preferred if several axial pins are provided which extend into recesses in the damper shell and/or in the second race. By way of example, the above-mentioned protruding axial pins could be provided on the second race in order to bring the second race to the damper shell in the axial direction with these axial pins dipping into the recesses within the damper shell and thus to achieve the non-rotatable fastening of the second race to the damper shell via the axial pins. Conversely, the axial pins could also be provided on the damper shell, such that when the damper shell and the second race are brought together axially, the axial pins enter the recesses inside the second race in order to achieve the non-rotatable fastening. However, it is equally possible, if not preferred, if corresponding recesses are provided in both the second race and the damper shell, which are aligned with one another in the axial direction, in order to insert said axial pins both into the recesses in the second race and into the recesses in the damper shell in the axial direction and thus to effect the non-rotatable fastening of the second race and the damper shell to each other. The said axial pins can preferably be rivets, such that fixing of the said parts to one another in the axial direction can also be effected. Consequently, the non-rotatable fastening can also be achieved by means of a riveted connection between the second race and the damper housing, wherein a riveted connection is an axial plug-in connection in the broader sense.

In a particularly preferred embodiment of the freewheel damper arrangement according to the invention, the second race in a radial section (82) of the freewheel damper arrangement (2) is non-rotatably fixed via the axial pins (76) to the damper shell (22), in which the second race (60) is arranged in order to achieve a compact structure.

In principle, the recesses in the damper shell and the axial pins can be matched to one another in such a way that the axial pins extending into the recesses of the damper shell do not affect the structural space of the other components of the torsional vibration damper, in particular the spring elements. In order to keep the machining and assembly effort particularly low, the axial pins in a further particularly preferred embodiment of the freewheel damper arrangement according to the invention are offset in the radial direction relative to the spring elements. It could also be said that the axial pins are at most partially aligned with the spring elements of the torsional vibration damper in the axial direction. It is particularly preferable if the axial pins are arranged offset in the radial direction relative to the spring elements of the torsional vibration damper in such a way that they are spaced apart from the spring elements in the radial direction. Depending on the space available in the radial direction, the axial pins could, for example, be arranged offset radially outwards relative to the spring elements or at a distance from the spring elements in order to be able to provide a starter freewheel with an advantageously large diameter of the second race, and thus also a starter freewheel with an advantageously large number of clamping elements. If this radial space is not available, however, the axial pins can also be arranged offset inwardly in the radial direction relative to the spring elements or at a distance from the spring elements in order not to restrict the space available for the spring elements inside the damper housing or to avoid increased manufacturing costs.

In an advantageous embodiment of the freewheel damper arrangement according to the invention, the starter freewheel has a first side part facing away from the damper shell, on which the clamping elements can be supported in the axial direction. The first side part is preferably an substantially annular disc-shaped first side part, which is preferably formed by a sheet metal part. In this way, the first side part can be arranged in a space-saving manner, for example, in axial alignment with both the second race and with the receiving space for the clamping elements between the first race and the second race, in order to ensure support of the clamping elements in the axial direction on the first side part.

In a particularly advantageous embodiment of the freewheel damper arrangement according to the invention, the first side part has an axial section, for example of tubular design, on which the second race and/or the damper shell and/or a further side part of the starter freewheel can be or is supported in the radial direction. Thus, for example, the said axial section can serve to centre the second side part with respect to the second race and/or the damper shell and/or a further side part of the starter freewheel and, moreover, effect a secure arrangement of at least one of the said components in relation to the first side part in the radial direction.

In a further advantageous embodiment of the freewheel damper arrangement according to the invention, the aforementioned axial section of the first side part is tubular and/or the axial section has a plurality of axial fingers, i.e. fingers extending in the axial direction. By way of example, the first side part can be composed in one piece of the ring-shaped section, on which the clamping elements can be supported in the axial direction, and the tubular section and/or the several axial fingers. It is particularly preferred if the axial section has a tubular section following the ring-disc shaped section and the axial fingers following the tubular section.

According to a further advantageous embodiment of the freewheel damper arrangement according to the invention, the axial fingers of the first side part extend to a side of the damper shell facing away from the starter freewheel in order to engage behind the side of the damper shell facing away from the starter freewheel while fixing the first side part in the axial direction on the damper shell. The axial fingers therefore also serve the purpose of axially securing the first side part. In this way, for example, the second race arranged between the first side part and the damper shell and, optionally, also a further side part can be fixed to the damper shell in the axial direction. In this embodiment, it is also preferred if the side of the damper shell facing away from the starter freewheel is gripped by means of a retaining ring arranged detachably on the axial fingers, in order to be able to achieve the axial fixing in a particularly simple manner or in an assembly-friendly manner In one variant of this design, it is also preferred if the axial fingers, optionally by means of the aforementioned retaining ring, engage behind the side of the damper shell facing away from the starter freewheel while pre-tensioning the first side part in the direction of the damper shell. Irrespective of the variant selected in each case, axial fixing of the first side part, the second race and any further side part on the damper shell can thus be achieved, such that the aforementioned pins for achieving the non-rotatable fastening of the second race to the damper shell do not in principle have to effect axial fastening, and therefore do not necessarily have to be designed as rivets. Rather, in this embodiment, it is preferred that the axial pins are not in the form of rivets, but have the sole function of producing a non-rotatable connection, while the axial fixing occurs via the axial fingers or the retaining ring arranged thereon.

In order to achieve a particularly compact design while reducing the number of parts, the second race is arranged directly on the damper shell in a further preferred embodiment of the freewheel damper arrangement according to the invention. Moreover, in this embodiment it is preferred if the clamping element of the starter freewheel can be supported directly on the damper shell in the axial direction, such that the damper shell or a section thereof has an additional function, which in conventional freewheels is performed by an additional side part. In order to preclude wear on the damper shell, it is also preferred if the damper shell has a hardened area on which the clamping elements can be or are supported in the axial direction.

As an alternative to the embodiment described above, in a further advantageous embodiment of the freewheel damper arrangement according to the invention, the second race is arranged indirectly on the damper shell with the interposition of a second side part of the starter freewheel facing the damper shell. The second side part is again preferably an substantially annular disc-shaped side part, which moreover is preferably designed as a sheet-metal part. As already described with reference to the first side part, the clamping elements can preferably be supported in the axial direction on the second side part of the starter freewheel, wherein the second side part is preferably arranged in axial alignment with the second race and the receiving space for the clamping elements of the starter freewheel.

In a further advantageous embodiment of the freewheel damper arrangement according to the invention, the second race together with the first side part and/or the second side part is fastened to the damper shell in a non-rotatable manner via the axial pins. If the axial pins are the rivet connection or rivets mentioned above, the second race is preferably fastened to the damper shell in the axial direction together with the first side part and/or second side part via the rivets.

In a further preferred embodiment of the freewheel damper arrangement according to the invention, the first race, which is preferably an inner first race of the starter freewheel, is rotatably mounted via a radial and/or axial bearing on the damper shell, a component non-rotatably connected to the damper shell or a stationary housing. The radial and/or axial bearing is preferably a roller bearing or plain bearing.

According to a further advantageous embodiment of the freewheel damper arrangement according to the invention, in which the first race is rotatably mounted via a radial and/or axial bearing on a component non-rotatably connected to the damper shell, the said component has a centring section for centring the component with the damper shell. The centring section can, for example, be an axial projection, optionally a tubular axial projection, on the substantially annular component.

In a further particularly advantageous embodiment of the freewheel damper arrangement according to the invention, the aforementioned component is a drive shaft non-rotatably connected to the damper shell or a support part non-rotatably connected to the damper shell and formed separately from the damper shell. The separate design of the support part from the damper shell is advantageous here in that complex machining of the damper shell can be dispensed with, while the support can be manufactured independently of the damper shell and specifically for the purpose of support, while the connection of the support part to the damper shell involves little assembly effort.

In a further preferred embodiment of the freewheel damper arrangement according to the invention, the support part, which is connected to the damper shell but formed separately from the damper shell, is arranged between the damper shell and a drive shaft non-rotatably connected to the damper shell. By way of example, the support can thus be clamped between the damper shell on the one hand and the drive shaft, for example the drive shaft of the internal combustion engine, when the damper shell and the drive shaft are fastened to one another. However, in order to be able to provide an advantageous contiguous module of torsional vibration damper and starter freewheel, which can be easily installed as a contiguous unit as part of the assembly of a drive train of the motor vehicle, it is preferred in this embodiment if the support part is attached to the damper shell, optionally riveted or screwed to it, independently of a fastening of the damper shell to a drive shaft. Consequently, the module boundary of module consisting of a torsional vibration damper and starter freewheel runs between the said module and the drive shaft, wherein the module only has to be non-rotatably fastened to the drive shaft during assembly.

In order to achieve a particularly compact structure of the freewheel damper arrangement in the axial direction, the first race, the second race and the intermediate clamping elements are arranged nested with one another in the radial direction.

According to a further advantageous embodiment of the freewheel damper arrangement according to the invention, the clamping elements can be supported, preferably directly, in the radial direction on the first and second races. In particular, the first and second races preferably have circumferential running surfaces facing each other, on which the clamping elements can be supported directly—and thus not indirectly via one of the side parts.

### BRIEF DESCRIPTION OF THE DRAWINGS

The invention is explained in more detail below by means of exemplary embodiments with reference to the accompanying drawings. They show:

FIG. 1 a partial side view of a first embodiment of a freewheel damper arrangement in sectional view and

FIG. 2 a partial side view of a second embodiment of a freewheel damper arrangement in sectional view.

### DETAILED DESCRIPTION

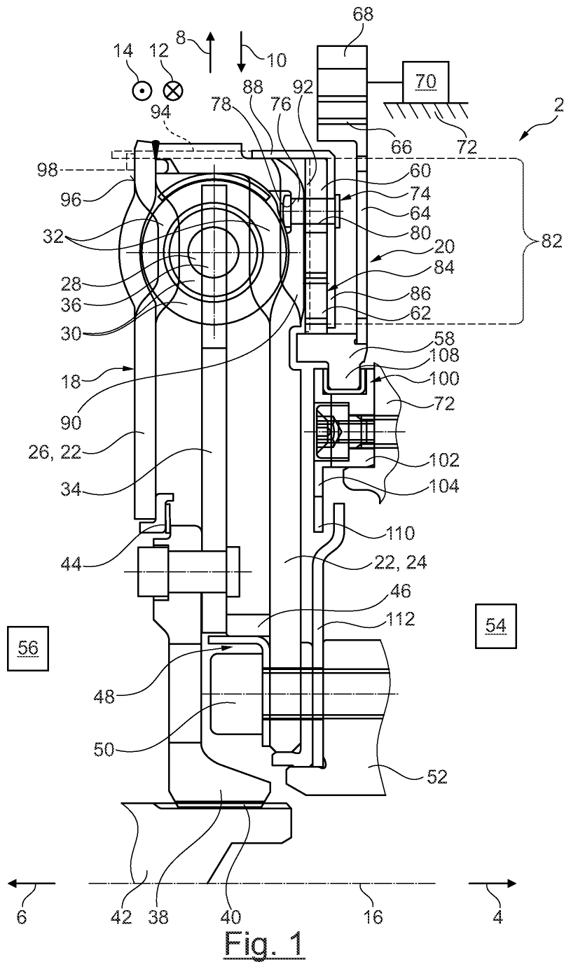

FIG. 1 shows a first embodiment of a freewheel damper arrangement 2 in a drive train of a motor vehicle. In the figures, the opposing axial directions 4, 6, the opposing radial directions 8, 10 and the opposing peripheral directions 12, 14 are indicated by corresponding arrows, wherein the freewheel damper arrangement 2 is rotatable around a central axis of rotation 16 extending in the axial directions 4, 6. The freewheel damper arrangement 2 is substantially composed of a torsional vibration damper 18 and a starter freewheel 20.

The torsional vibration damper 18 has a damper shell 22 which is composed of two damper half-shells 24, 26 opposite each other in the axial direction 4, 6. In the radial direction 8 outwards, a spring receiving space 28 is formed peripherally in the peripheral direction 12, 14 and in the axial direction 4, 6 between the two damper half-shells 24, 26. Spring elements 30 are likewise arranged peripherally in the peripheral direction 12, 14 inside the spring receiving space 28 and are preferably in the form of helical springs, wherein the helical springs can particularly preferably be in the form of straight helical springs or curved helical springs. On the two damper half-shells 24, 26 of the damper shell 22, protruding rotary drivers 32 are integrally formed in the spring receiving space 28, which cooperate with the spring elements 30. The damper shell 22 is designed as a primary element of the torsional vibration damper 18, such that it represents the input side of the torsional vibration damper 18 to which a torque is applied directly or indirectly via a drive unit, preferably an internal combustion engine. The secondary element of the torsional vibration damper 18, i.e. its output side, is formed by a damper flange 34, which extends substantially in the form of a disc in the radial directions 8, 10 and has rotary drivers 36 on the outside in the radial direction 8, which extend into the spring receiving space 28 in order to cooperate with the spring elements 30. Consequently, the damper flange 34 is coupled torsionally elastically to the damper shell 22 via the spring elements 30 in the peripheral direction 12, 14. In the radial direction 10 inwards, the damper flange 34 is provided with an output hub 38 which, in the present example, has been non-rotatably attached to the damper flange 34. The output hub 38 is in rotary driving connection with a transmission input shaft 42 via a plug-in toothing 40. Moreover, the damper flange 34 is pre-tensioned in the axial direction 4 against an axial bearing 46 between the damper flange 34 and the damper half-shell 24 via a spring device 44 arranged between the damper shell 22, or more precisely the damper half-shell 26, and the damper flange 34. The axial bearing 46, designed here as a simple support ring, is supported in the radial direction 8, 10 on a retaining part 48, which is fastened to the damper shell 22 by means of a screw 50 or another fastening means, wherein the screw 50 or the other fastening means equally serve the non-rotatable fastening of the damper shell 22 to the drive shaft 52. The drive shaft 52 can, for example, be the end of a crankshaft of an internal combustion engine, but can also be another component of the drive train which is in rotary drive connection with such an internal combustion engine or its crankshaft.

It is thus first apparent from the preceding description that the torsional vibration damper 18 is arranged in the axial direction 4, 6 between a drive unit 54, for example an internal combustion engine, and a transmission 56, which are only schematically indicated in the figures. The starter freewheel 20 mentioned above is arranged in the axial section between the torsional vibration damper 18 and the drive unit 54. The starter freewheel 20 has a first race 58 located on the inside in the radial direction 10 and a second race 60 located on the outside in the radial direction 8, which are arranged in a nested manner in the radial direction 8, 10 and have supporting sides facing one another in the radial direction 8 or 10, between which supporting sides a receiving space for clamping elements 62 is formed which runs in the peripheral direction 12, 14, wherein the clamping elements 62 are preferably designed as clamping rollers. The clamping elements 62 are also arranged nested with the races 58, 60 in the radial direction 8, 10, such that they can be or are supported on the support side of the first race 58 pointing outwards in the radial direction 8 and on the support side of the second race 60 pointing inwards in the radial direction 10. The starter freewheel 20 further comprises a disc-shaped torque transmission member 64 extending substantially in the radial direction 8, 10, which is non-rotatably fixed in the radial direction 10 inwardly on the first race 58 and extends outwardly therefrom in the radial direction 8 and in the axial direction 4 adjacent to the clamping elements 62 and the second race 60. At the end of the torque transmission member 64 pointing outwards in the radial direction 8, a ring gear 66 is formed which is permanently engaged with an output pinion 68 of a starter motor 70, such that one can also speak of a permanently engaged starter freewheel 20. The starter motor 70 is preferably designed as an electric motor and is arranged on a housing 72, in this case the housing of the drive unit 54. Consequently, the first race 58 can be driven by the starter motor 70 via the output pinion 68, the ring gear 66 and the torque transmission member 64, such that the first race 58 can also be referred to as the input side of the starter freewheel 20 in relation to the starter motor 70.

The second race 60 of the starter freewheel 20, on the other hand, is assigned to the damper shell 22, or more precisely to the damper half-shell 24 of the damper shell 22, and is thus non-rotatably attached to the damper shell 22 or damper half-shell 24. The second race 60 is non-rotatably attached to the damper half-shell 24 of the damper shell 22 by means of an axial plug-in connection 74, wherein a plurality of axial pins 76 are used for this purpose, which extend on the one hand into recesses 78 in the damper half-shell 24 of the damper shell 22 and on the other hand into recesses 80 in the second race 60 in order to non-rotatably attach the damper shell 22 and the second race 60 to each other. It has been found to be advantageous if at least three axial pins 76 are provided, which are particularly preferably arranged equally spaced apart from one another in the peripheral direction 12, 14. As can be seen from FIG. 1, the second race 60 is non-rotatably fixed to the damper shell 22 via the axial pins 76 in a radial section 82 of the freewheel damper arrangement 2, by the second race 60 extending or being arranged in order to achieve a non-rotatable connection between the damper shell 22 and the second race 60 that is as direct and space-saving as possible.

In the depicted embodiment, the axial pins 76 are formed as rivets, wherein the axial pins 76 in the form of rivets equally effect a fixing of the second race 60 in both axial directions 4, 6 on the damper shell 22. Deviating from FIG. 1, the axial pins 76 can also be arranged on the second race 60 in a fixed manner or even integrally therewith in order to insert the protruding axial pins 76 into the recesses 78 in the damper shell 22 in the axial direction 6. Conversely, however, the axial pins 76 could also be arranged on the damper shell 22 from the outset or even be formed integrally therewith in order to insert them into the recesses in the second race 60 during assembly in the axial direction 4.

The starter freewheel 20 has a first side part 84 on its side facing away from the damper shell 22 in the axial direction 4. The first side part 84, which is preferably designed as a sheet metal part, has a radial section 86 in the form of an annular disc on which the clamping elements 62 can be or are supported in the axial direction 4. An axial section 88 adjoins the radial section 86 in the radial direction 8 outwards and extends from the radial section 86 in the axial direction 6. In a first extension range, the axial section 88 is substantially tubular. The axial section 88 can be or is supported in the radial direction 8, 10 on the radially outwardly facing side of the second race 60 and on the radially outward facing side of the damper shell 22, and vice versa, such that the axial section 88, which is integrally formed with the radial section 86, effects both an exact positioning of the first side part 84 and an exact positioning of the second race 60 relative to the damper shell 22. Also, the second race 60 is non-rotatably secured to the damper shell 22 together with the first side portion 84 via the axial pins 76 formed as rivets.

In FIG. 1, the second race 60 is arranged directly on the damper shell 22, such that the side of the second race 60 facing in the axial direction 6 is supported on the side of the damper half-shell 24 of the damper shell 22 facing in the axial direction 4. The clamping elements 62 can also be supported or are supported directly on the damper half-shell 24 of the damper shell 22 in the axial direction 6, wherein the damper shell 22 or the damper half-shell 24 in this case can preferably have a hardened region 90 on which the clamping elements 62 can be or are supported in the axial direction 6 in order to ensure low-wear operation. In this case, the hardened region 90 is preferably harder than at least one other area of the damper half-shell 24 or of the damper shell 22.

Alternatively, however, a second embodiment variant is also indicated with dashed lines in FIG. 1, in which the second race 68 is arranged and fastened indirectly to the damper shell 22 with the interposition of a second side part 92 of the starter freewheel 20 facing the damper shell 22 in the axial direction. The second side part 92 indicated by dashed lines in FIG. 1 is substantially annular disc-shaped and is preferably formed from a sheet metal part, wherein the second side part 92 is arranged both in the axial direction 4, 6 between the second race 60 and the damper shell 22 and in the axial direction 4, 6 between the second race 60 and the damper shell 22, such that the clamping elements 62 can be or are supported in the axial direction 6 on the second side part 92. Notwithstanding this, the non-rotatable fastening of the second race 60 in this second embodiment continues to be effected via the axial pins 76 arranged in the radial section 82, as has already been described above. It can also be seen from FIG. 1 that such a second side part 92, together with the second race 60 and the first side part 84, is non-rotatably attached to the damper shell 22 via the axial pins 76. Moreover, the axial section 88 of the first side part 84 is formed in such a way that it also surrounds the second side part 92 on the outside in the radial direction 8, such that it is preferred if the side of the second side part 92 facing outwards in the radial direction 8, 10 can be or is supported on the axial section 88 of the first side part 84 in order to achieve an exact positioning of the first and second side parts 84, 92 relative to each other.

FIG. 1 also indicates a third embodiment variant. In the third embodiment variant, the axial section 88 of the first side part 84 has, as an alternative or supplement to the substantially tubular section, the axial fingers 94 indicated with dashed lines in FIG. 1, in which case a plurality of axial fingers 94 spaced apart from one another in the peripheral direction 12, 14 are preferably provided. The axial fingers 94, which are in turn formed integrally with the first side part 84, extend in the axial direction 6 as far as a side 96 of the damper shell 22 facing away from the starter freewheel 20, in order to engage behind the side 96 facing away from the starter freewheel 20. The engaging behind is preferably carried out by means of a retaining ring 98 arranged on the end sections of the axial fingers 94 pointing in the axial direction 6 and effects a fixing of the first side part 84 in the axial direction 4 on the damper shell. Also, this fixing is preferably effected under bias of the first side part 84 in the axial direction 6, thus in the direction of the damper shell 22. More precisely, this allows the radial section 86 to be biased in the axial direction 6 against the second race 60, which in turn is biased against the damper shell 22 in the axial direction 6. Insofar as the previously mentioned second side part 92 is also provided, this would also be clamped between the second race 60 and the damper shell 22 or biased against the damper shell 22. Consequently, in this third embodiment, the rivet-shaped design of the axial pins 76 could also be dispensed with in principle, in particular since the axial fixing of the damper shell 22 and starter freewheel 20 to each other would be effected via the first side part 84 or its axial finger 84 or its axial finger 94 and the retaining ring 98. Consequently, the first side part 84 would assume the function of an axial fixing to each other, while the axial pins, designed as simple pins without rivet shape, could be reduced to the function of a rotationally fixed fixing of the second race 60 to the damper shell 22. In such a third embodiment, the fixing of the second race 60 could be performed either by the axial section 88 of the first side part 84 or by the axial pins 76 or by a combination of both. Regardless of this, however, the axial pins 76 as shown in FIG. 1 could actually be in the form of a rivet, while the first side part 84 together with the radial section 86, the axial section 88 and the retaining ring 98 serve to pre-fasten the second race 60 to the damper shell 22 before the axial pins 76 are transferred to their riveted form shown in FIG. 1 in order to finally and non-detachably fasten the second race 60 to the damper shell 22.

Independently of the respective embodiment, the radially inner first race 58 of the starter freewheel 20 is rotatably mounted via a radial and/or axial bearing 100 on a stationary and thus non-rotating housing, which in the embodiment shown is formed by the housing 72 of the drive unit 54, wherein the depicted bearing is designed as a radial and axial bearing 100 and as a sliding bearing. Alternatively, however, the radial and/or axial bearing 100 could also be designed as a roller bearing, although the design as a sliding bearing is preferred in this embodiment. In the depicted embodiment, the radial and axial bearing 100 shown in FIG. 1 is advantageously composed of two bearing sections detachably fastened to each other, namely a first bearing section 102 on the housing side and a second bearing section 104 detachably fastened thereto. In the axial direction 4, 6 between the bearing sections 102, 104, which in this case are detachably fastened to one another by means of at least one screw, a bearing groove 106 is formed which points outwards in the radial direction 8 and into which a sliding section 108 of the first race 48 enters while slidingly supporting the latter in the radial direction 8, 10 and axial direction 4, 6. During assembly or disassembly, the second bearing section 104 can be disengaged from the first bearing section 102 to allow the sliding section 108 to be inserted in the axial direction 4 or removed in the axial direction 6.

The second bearing section 104 also has a retaining section 110 projecting inwardly in the radial direction 10. The retaining section 110 is arranged in the axial direction 4, 6 between the damper shell 22 on the one hand and a retaining part 112 on the other, wherein the retaining section 110 is aligned with the damper shell 22 and retaining part 112 in the axial direction 4, 6. The second bearing section 104 with its retaining section 110 thus not only has the function of a secure bearing of the first race 58, but the interaction between the retaining section 110 and the retaining part 112 additionally serves to limit the movement of the drive shaft 52 relative to the housing 72 in the axial direction 6, also in order to ensure the cohesion of the starter freewheel 20 in the axial direction 4, 6. For this purpose, the retaining part 112 is fixed to the damper shell 22 in the axial direction 4, 6, wherein this is an indirect fixing in the depicted embodiment. Thus, the retaining part 112 is clamped in the axial direction 4, 6 between the drive shaft 52 and the damper half-shell 24 of the damper shell 22 when the damper shell is non-rotatably connected to the drive shaft 52 via the previously mentioned screw 50. This screw 50 or the plurality of screws 50 thus serve(s) both to fix the retaining part 48 for retaining the axial bearing 56 and to fix the retaining part 112 for limiting the movement of the drive shaft 52 or torsional vibration damper 18 in the axial direction 6 relative to the housing 72 of the drive unit.

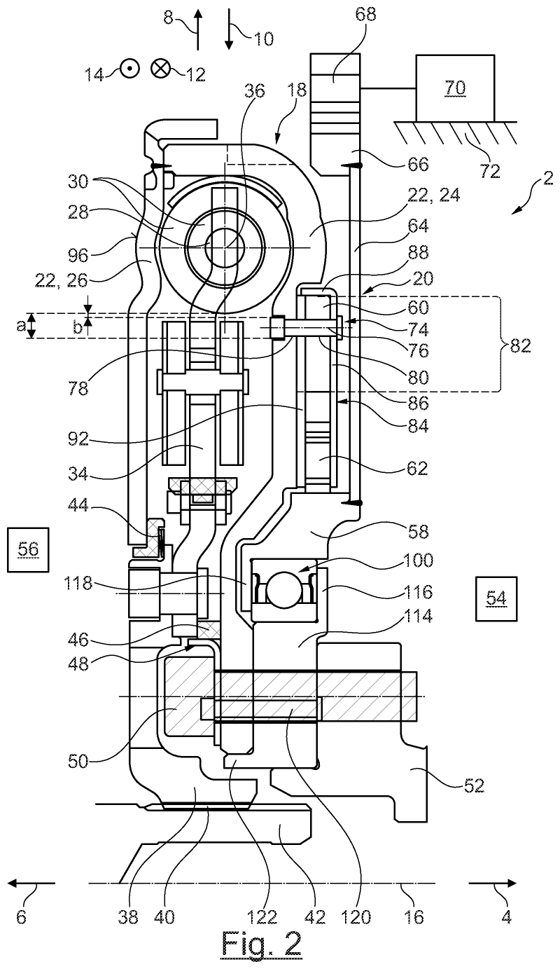

FIG. 2 shows a second embodiment of a freewheel damper arrangement 2, which substantially corresponds to the freewheel damper arrangement according to FIG. 1, such that below only the differences are discussed, the same reference numerals are used for the same or similar parts and the preceding description otherwise applies accordingly.

In the second embodiment, the axial pins 76 for non-rotatable fastening of the second race 60 to the damper shell 22 are offset in the radial direction 8, 10, here in the radial direction 10 inwards, relative to the spring elements 30 of the torsional vibration damper 18, as indicated by the offset a in the radial direction 8, 10 in FIG. 2. In addition, said axial pins 76 are also spaced apart from the spring elements 30 in radial direction 8, 10, here in radial direction 10 inwards, as indicated by the distance b in FIG. 2. This has the advantage that the axial pins 76 with their ends pointing in the axial direction 6 do not restrict the installation space required for the spring elements 30, more precisely the spring receiving space 28, or even make it necessary to adapt the spring receiving space 28 or the spring elements 30. Although a corresponding arrangement of the axial pins is not shown in the first embodiment according to FIG. 1, it should be clarified that also in the first embodiment according to Fig. 1, the axial pins 76 can be arranged offset in radial direction 8, 10 with respect to the spring elements 30 or even arranged at a distance from the spring elements 30 in the radial direction 8, 10. In principle, the axial pins 76 do not have to be offset inwardly in the radial direction 10 relative to the spring elements or spaced apart from them, as shown in FIG. 2; rather, the axial pins can also be offset outwardly in the radial direction 8 relative to the spring elements 30 or spaced apart outwardly in the radial direction 10 from the spring elements 30, if the radial installation space permits this. However, the design variant shown in FIG. 2 is preferred, especially since a section of the damper half-shell 24 is provided anyway in the radial direction 10 inwards, to which section the axial pins 76 can be connected, without such a section having to be created additionally in the radial direction 8 outside the spring elements 30.

Also in the second embodiment according to FIG. 2, the first race 58 is rotatably mounted via the radial and/or axial bearing 100, which in this case is designed as a radial and axial bearing 100, wherein the radial and axial bearing 100 in the depicted embodiment is designed as a roller bearing. However, the support is not provided on a fixed housing such as the housing 52 in FIG. 1, but rather on a component which is non-rotatably connected to the damper shell 22 and which is hereinafter referred to as the support part 114. The support part 114 can in principle be formed integrally with the damper shell 22 or the damper half-shell 24, such that it is also possible to speak of a rotatable mounting on the damper shell 22, but in the embodiment depicted, the support part 114 is formed as a component formed separately from the damper shell 22. Furthermore, the component could also be formed by a section of the drive shaft 52 which is non-rotatably connected to the damper shell 22. However, for the reasons stated below, the embodiment shown in FIG. 2 is advantageous.

As already described above, the support part 114 is formed separately from the damper shell 22, but is non-rotatably connected to the damper shell 22 or the damper half-shell 24. The radial and axial bearing 100 in the form of the roller bearing is arranged on the side of the substantially annular disc-shaped support part 114 facing outwards in the radial direction 8, wherein the support part 114 further has a support section 116 on which the roller bearing can be or is supported in the axial direction 4. On the other hand, the roller bearing is arranged on a side of the first race 58 facing inwards in the radial direction 10, wherein the first race 58 further comprises a support section 118 on which the roller bearing is or can be supported in the axial direction 6. The support part 114 is fastened to the damper shell 22 or the damper half-shell 24 via fastening means 120 independently of a fastening of the damper shell 22 to the drive shaft 52, wherein the fastening means 120 can be formed by rivets or screws, for example. The indicated fastening of the damper shell 22 to the drive shaft 52, which is again achieved here by the at least one screw 50, is effected in such a way that the support part 114 is arranged or clamped in the axial direction 4, 6 between the damper shell 22 and the drive shaft 52, which is non-rotatably connected to the damper shell 22. Thanks to the fastening of the support part 114 via the fastening means 120 to the damper shell 22, which is independent of the screw connection by the screws 50, a coherent module consisting of torsional vibration damper 18 and starter freewheel 20 is achieved in an advantageous manner, the module boundary of which runs between the support part 114 and the drive shaft 52 on the one hand and the output hub 38 and the transmission input shaft 42 on the other hand. In such a coherent module, all the components shown are arranged captively, which allows easy handling during assembly and disassembly of the module within the drive train of a motor vehicle. Moreover, in order to achieve simple centring of the support part 114 in relation to the damper shell 22, the support part 114 has a centring section 122 which projects in the axial direction 6 and runs around in the peripheral direction 12, 14 and, in the embodiment shown, interacts in a centring manner with the edge of the damper half-shell 24, which points inwards in the radial direction 10.

In principle, the fastening means 120 could be dispensed with in favour of a clamping fastening of the support part 114 between the damper shell 22 and the drive shaft 52 with the aid of the screws 50, but this would not achieve the advantageous modular design described above to the desired extent.

### REFERENCE NUMERAL LIST

2 freewheel damper arrangement
4 axial direction
6 axial direction
8 radial direction
10 radial direction
12 peripheral direction
14 peripheral direction
16 axis of rotation
18 torsional vibration damper
20 starter freewheel
22 damper shell
24 damper half-shell
26 spring receiving space
28 spring receiving space
30 spring elements
32 rotary driver
34 damper flange
36 rotary driver
38 output hub
40 plug-in toothing
42 transmission input shaft
44 spring device
46 axial bearing
48 retaining part
50 screw
52 drive shaft
54 drive unit
56 transmission
58 first race
60 second race
62 clamping elements
64 torque transmission member
66 ring gear
68 output pinion
70 starter motor
72 housing
74 axial plug-in connection
76 axial pins
78 recesses
80 recesses
82 radial section
84 first side part
86 radial section
88 axial section
90 hardened region
92 second side part
94 axial fingers
96 side
98 retaining ring
100 radial and/or axial bearing
102 first bearing section
104 second bearing section
106 bearing groove
108 sliding section
110 retaining section
112 retaining part
114 support part
116 support section
118 support section
120 fastening means
a offset
b distance

1. A freewheel damper arrangement (2) for a motor vehicle having a torsional vibration damper (18) having a damper shell (22), spring elements (30) arranged in the damper shell (22) and a damper flange (34) coupled torsionally elastically to the damper shell (22) via the spring elements (30), and a starter freewheel (20) having a first race (58) which can be driven by a starter motor (70) and a second race (60) which is assigned to the damper shell (22), between which clamping elements (62) are arranged, characterised in that the second race (60) is non-rotatably fastened to the damper shell (22).

2. The freewheel damper arrangement (2) according to claim 1, wherein the second race (60) is non-rotatably fastened to the damper shell (22) via an axial plug-in connection (74), wherein preferably a plurality of axial pins (76), optionally rivets, are provided, which extend in recesses (78; 80) in the damper shell (22) and/or in the second race (60), wherein the second race (60) is particularly preferably non-rotatably fastened to the damper shell (22), in which the second race (60) is arranged, in a radial section (82) of the freewheel damper arrangement (2) via the axial pins (76).

3. The freewheel damper arrangement (2) according to claim 2, wherein the axial pins (76) are offset in the radial direction (8; 10) with respect to the spring elements (30), preferably spaced apart from the spring elements (30) in the radial direction (8; 10).

4. The freewheel damper arrangement (2) according to claim 1, wherein the starter freewheel (20) has a first side part (84) which faces away from the damper shell (22) and on which the clamping elements (62) can be supported in the axial direction (4), wherein the first side part (84) preferably has an axial section (88) on which the second race (60) and/or the damper shell (22) and/or a further side part (92) can be or is supported in the radial direction (8, 10) and which is particularly preferably designed to be tubular and/or has a plurality of axial fingers (94).

5. The freewheel damper arrangement (2) according to claim 4, wherein the axial fingers (94) extend up to a side (96) of the damper shell (22) facing away from the starter freewheel (20), around the side (96) of the damper shell (22) facing away from the starter freewheel (20), optionally by means of a retaining ring (98) arranged detachably on the axial fingers (94), while fixing the first side part (84) in the axial direction (4, 6) on the damper shell (22) and preferably while pre-tensioning the first side part (84) in the direction of the damper shell (22).

6. The freewheel damper arrangement (2) according to claim 1, wherein the second race (60) is arranged directly on the damper shell (22), wherein the clamping elements (62) can preferably be supported directly on the damper shell (22) in the axial direction (6), and the damper shell (22) particularly preferably has a hardened region (90) on which the clamping elements (62) can be supported in the axial direction, or the second race (60) is arranged on the damper shell (22) with the interposition of a second side part (92) of the starter freewheel (20) facing the damper shell (22), on which the clamping elements (62) can preferably be supported in the axial direction (6).

7. The freewheel damper arrangement (2) according to claim 4, wherein the second race (60), together with the first side part (84) and/or second side part (92), is non-rotatably fastened to the damper shell (22) via the axial pins (76), optionally rivets.

8. The freewheel damper arrangement (2) according to claim 1, wherein the first race (58) is rotatably mounted on the damper shell (22) via a radial and/or axial bearing (100), preferably a roller bearing or plain bearing, a component non-rotatably connected to the damper shell (22) or a stationary housing (72), wherein the component particularly preferably has a centring section (122), optionally an axially projecting centring section (122), for centring with the damper shell (22).

9. The freewheel damper arrangement (2) according to claim 6, wherein the component is a drive shaft (52) non-rotatably connected to the damper shell (22) or a support part (114) non-rotatably connected to the damper shell (22) and formed separately from the damper shell (22), which is preferably arranged between the damper shell (22) and a drive shaft (52) non-rotatably connected to the damper shell (22) and is particularly preferably fastened to the damper shell (22), optionally riveted or screwed thereto, independently of a fastening of the damper shell (22) to a drive shaft (52).

10. The freewheel damper arrangement (2) according to claim 1, wherein the first race (58), the second race (60) and the clamping elements (62) are arranged nested with one another in the radial direction (8, 10) and/or the clamping elements (62) can be supported, preferably directly, in the radial direction (8, 10) on the first and second races (58, 60).
